(19) United States
(12) Patent Application Publication
(10) Pub. No.: US 2014/0120200 A1
(43) Pub. Date: May 1, 2014

(54) STRETCHING AND CLAMPING DEVICE FOR ANISOTROPY CONDUCTIVE FILM AND CLAMPING ROLLER AND CLAMPING HEAD THEREOF

(71) Applicant: SHENZHEN CHINA STAR OPTOELECTRONICS TECHNOLOGY CO. LTD., Shenzhen, Guangdong (CN)

(72) Inventors: FangFu CHEN, Shenzhen, Guangdong (CN); Tao DING, Shenzhen, Guangdong (CN); Guodong ZHAO, Shenzhen, Guangdong (CN); Yijun LIU, Shenzhen, Guangdong (CN)

(73) Assignee: SHENZHEN CHINA STAR OPTOELECTRONICS TECHNOLOGY CO., LTD, Shenzhen,Guangdong (CN)

(21) Appl. No.: 13/807,303

(22) PCT Filed: Nov. 6, 2012
(86) PCT No.: PCT/CN12/84127

§ 371 Date: Dec. 28, 2012

(30) Foreign Application Priority Data
Oct. 29, 2012 (CN) 201220559706.8

(51) Int. Cl. G02F 1/13

(52) U.S. Cl. CPC G02F 1/1303
USPC 425/394

(57) ABSTRACT

A stretching and clamping device for anisotropy conductive film and a clamping roller and a clamping head thereof are provided. The clamping roller and the clamping head cooperate with each other to position and bond the anisotropy conductive film. The clamping roller is shaped as a regular prism and is capable of rotating around a rotating shaft thereof. The stretching and clamping device for anisotropy conductive film of the present disclosure can increase the friction between the stretching and clamping device and the paper strip with the anisotropy conductive film overlaid thereon, avoid a sliding situation occurred during the operation, allow the length of the stretched anisotropy conductive film to meet product manufacturing specification, improve the clamping precision and clamping stability, improve the yield rate of the bonding of the anisotropy conductive film, and reduce production cost.

### BACKGROUND

1. Technical Field

The present disclosure relates to liquid crystal displaying technologies, and particularly, to a stretching and clamping device for anisotropic conductive film and a clamping roller and a clamping head thereof.

2. Description of Related Art

In the package technology of Chip on Film (COF) of a liquid crystal panel, in order to carry electronic components, an anisotropy conductive film (ACF) is bonded onto a substrate on which a liquid crystal panel, the COFs, and a printed circuit board assembly are configured. Generally, an ACF bonding system as shown in FIG. 1 is used for bonding the ACF onto the substrate. A clamping roller 11 and a clamping head 12 of a stretching and clamping device cooperate with each other to clamp a paper strip 13. A cylinder 14 of the stretching and clamping device 10 controls the moving route of the paper strip 13 and further controls the moving distance of the paper strip 13. During the movement of the paper strip 13, an ACF supplying roller 15 overlays the ACF on a peeling layer of the paper strip 13. A cutter 16 cuts off the ACF after the length of the ACF reaches a predetermined value. After the stretching and clamping device 10 stops clamping the paper strip 13, the paper strip 13 stops moving and a compression bonding head 17 moves downwards to bond the ACF onto the substrate (not shown in the drawing) located under the compression bonding head 17. The length of the ACF bonded on the substrate is equal to the predetermined value. After that, the stretching and clamping device 10 continuously clamps the paper strip 13 until the paper strip 13 enters a recycling member 18. At present, the clamping roller 11 is made of resin and is cylinder-shaped, and the clamping head 12 is made of stainless steel and is pyramid-shaped. However, in the frequent clamping operation, since the clamping roller 11 is worn heavily, the friction factor of the clamping roller 11 is decreased, causing the paper strip 13 with the ACF overlaid thereon to slide. At this state, the length of the stretched ACF does not meet product manufacturing specifications, which results in unqualified bonding of the ACF and unqualified indentation, results in reprocessing of the products and crashes of the equipments, greatly affects the yield rates of the qualities of the products and operation rates of the equipments, and further results in increased production cost of the products.

### SUMMARY

The present disclosure provides a clamping roller of a stretching and clamping device for anisotropy conductive film, which improves the yield rate of the bonding of the anisotropy conductive film and reduces production cost.

The present disclosure further provides a clamping head of a stretching and clamping device for anisotropy conductive film, which improves the yield rate of the bonding of the anisotropy conductive film and reduces production cost.

The present disclosure further yet provides a stretching and clamping device for anisotropy conductive film, which improves the yield rate of the bonding of the anisotropy conductive film and reduces production cost.

The clamping roller of a stretching and clamping device for anisotropy conductive film is provided. The clamping roller is shaped as a regular prism and is capable of rotating around a rotating shaft thereof.

Preferably, a Teflon film is attached on each side of the clamping roller.

The clamping head of a stretching and clamping device for anisotropy conductive film is provided. The clamping head is used for cooperating with a clamping roller which is shaped as a regular prism and is capable of rotating around a rotating shaft thereof to position and bond the anisotropy conductive film. One end of the clamping head corresponding to one side of the clamping roller is used as a front end of the clamping head, the other end of the clamping head opposite to the front end is connected to a retractable device which is capable of driving the clamping head to move towards the clamping roller or to move away from the clamping roller.

Preferably, one end of the clamping head corresponding to one side of the clamping roller is used as a front end of the clamping roller, the other end of the clamping head opposite to the front end is connected to a retractable device which is capable of driving the clamping head to move towards the clamping roller or to move away from the clamping roller.

Preferably, a surface of the front end of the clamping head is rough.

Preferably, a plurality of stripe-shaped grooves are formed in the surface of the front end of the clamping head.

Preferably, the clamping head is cuboid-shaped or cylinder-shaped.

The stretching and clamping device for anisotropy conductive film is provided. The stretching and clamping device includes a clamping head, and a clamping roller cooperating with the clamping head to position and bond the anisotropy conductive film, the clamping roller being shaped as a regular prism and being capable of rotating around a rotating shaft thereof.

Preferably, one end of the clamping head corresponding to one side of the clamping roller is used as a front end of the clamping head, the other end of the clamping head opposite to the front end is connected to a retractable device, and the retractable device drives the clamping head to move towards the clamping roller or to move away from the clamping roller.

Preferably, a surface of the front end of the clamping head is rough.

Preferably, a plurality of stripe-shaped grooves are formed in the surface of the front end of the clamping head.

Preferably, the clamping head is cuboid-shaped or cylinder-shaped.

Preferably, the clamping head is shaped as a regular eight prism or a regular six prism.

Preferably, a Teflon film is attached on each side of the clamping roller.

Preferably, the front end of the clamping roller is cone-shaped.

Preferably, the clamping roller is made of stainless steel.

Preferably, a Teflon film is attached on each side of the clamping roller.

Preferably, one end of the clamping head corresponding to one side of the clamping roller is used as a front end of the clamping head, the other end of the clamping head opposite to the front end is connected to a retractable device, the retractable device drives the clamping head to move towards the clamping roller or to move away from the clamping roller.

Preferably, a surface of the front end of the clamping head is rough.

Preferably, a plurality of stripe-shaped grooves are formed in the surface of the front end of the clamping head.

The present disclosure is capable of increasing the friction between the stretching and clamping device and the anisotropy conductive film, which avoids a sliding situation occurred during the operation, allows the length of the stretched anisotropy conductive film to meet product manufacturing specifications, improves the clamping precision and clamping stability, improves the yield rate of the bonding of the anisotropy conductive film, and reduces production cost.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a present stretching and clamping device for anisotropy conductive film;

FIG. 2 is a schematic view of a stretching and clamping device for anisotropy conductive film in accordance with a first embodiment of the present disclosure;

FIG. 3 is a schematic view of a stretching and clamping device for anisotropy conductive film in accordance with a first embodiment of the present disclosure.

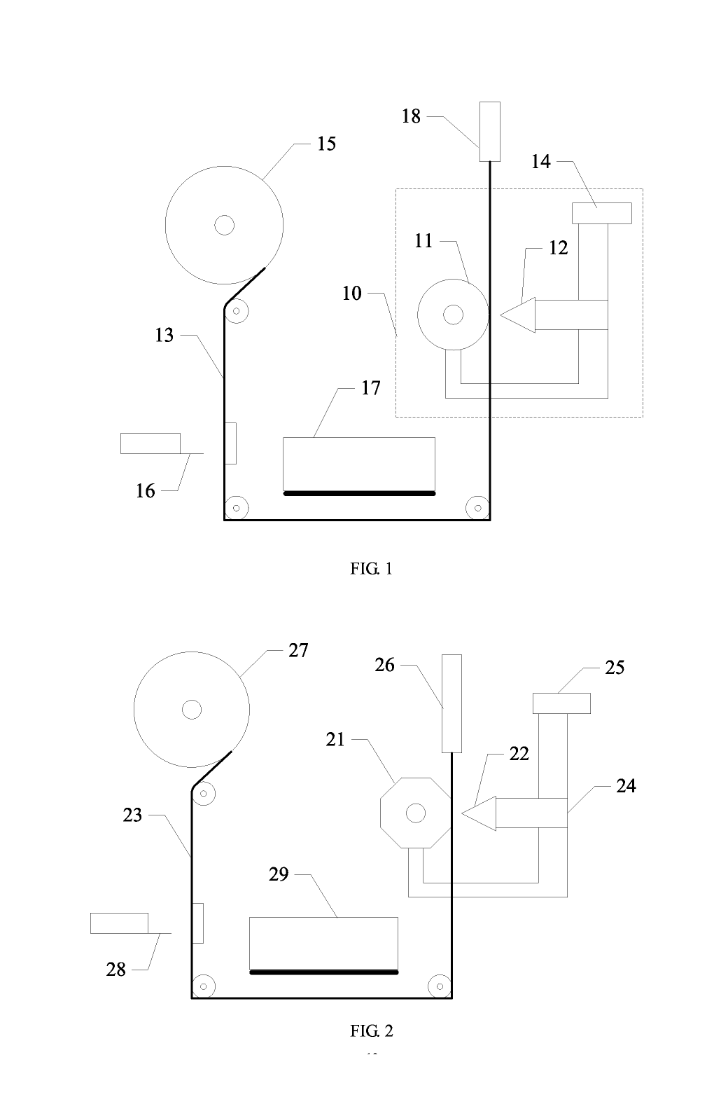

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 2, a stretching and clamping device for anisotropy conductive film in accordance with a first embodiment of the present disclosure is schematically shown. A clamping roller 21 of the present disclosure cooperates with a clamping head 22 to position and bond an anisotropy conductive film. The clamping roller 21 is shaped as a regular prism such as a regular eight prism or a regular six prism. In the embodiment, the clamping roller 21 is shaped as a regular eight prism. One side of the clamping roller 21 shaped as a regular eight prism corresponds to a front end of the clamping head 22. One end of the clamping head 22 opposite to the front end is connected to a retractable device 24 which is capable of driving the clamping head 22 to move towards the clamping roller 21 or to move away from the clamping roller 21.

At an initial position, the retractable device 24 drives the clamping head 22 to move towards the clamping roller 21. A paper strip 23 with an anisotropy conductive film overlaid thereon is clamped between the clamping roller 21 and the clamping head 22. A cylinder 25 controls the clamping roller 21 and the clamping head 22 to move towards a recycling member 26, thereby driving the paper strip 23 to move together. Meanwhile, an ACF supplying roller 27 overlays the ACF on a peeling layer of the paper strip 23 to stretch the paper strip 23. A cutter 28 cuts off the ACF after a length of the stretched ACF reaches a predetermined value. After a segment of the paper strip 23 with the ACF of the predetermined length overlaid moves to be located above a to-be-bonded position on a substrate (not shown in the drawing), the clamping roller 21 and the clamping head 22 stop moving, and a compression bonding head 29 presses the paper strip 23 to bond the ACF onto the substrate located under the compression bonding head 29. The length of the bonded ACF is equal to the predetermined value. After that, the clamping roller 21 and the clamping head 22 continuously move towards the recycling member 26 until reaching a final position in front of the recycling member 26, thus, the paper strip 23 is brought back to the recycling member 26. At this time, the retractable device 24 drives the clamping head 22 to move away from the clamping roller 21 to release the paper strip 23, and the cylinder 25 controls the clamping roller 21 and the clamping head 22 to move away from the recycling member 26 to back to the initial position.

In the stretching and clamping device having the clamping roller 21 shaped as a regular prism, when stretching and clamping the paper strip 23, one side of the clamping roller 21 contacts the paper strip 23 with the anisotropy conductive film overlaid thereon. Compared to the present cylinder-shaped clamping roller, the contacting area between the clamping roller 21 of the present disclosure and the paper strip 23 with the anisotropy conductive film overlaid thereon is increased, which increases the friction factor of the clamping roller 21 and avoids a sliding situation during the operation. This allows the length of the stretched anisotropy conductive film to meet product manufacturing specifications, improves the clamping precision and clamping stability, improves the yield rate of the bonding of the anisotropy conductive film, and reduces production cost. Additionally, a Teflon film can be attached on each side of the clamping roller 21 to further increase the friction factor of the clamping roller 21. Furthermore, the clamping roller 21 can be made of stainless steel to increase abradability thereof.

Additionally, the clamping roller 21 can rotate around a rotating shaft thereof. After the number of the stretching and clamping operation of the clamping roller 21 reaches a preset threshold value, the clamping roller 21 rotates over a predetermined angle automatically or is rotated over a predetermined angle manually to allow another side of the clamping roller 21 to be switched to correspond to the clamping head 22. Since the stretching and clamping operation is not carried out throughout on one side of the clamping roller 21 and the side of the clamping roller 21 which contacts the paper strip 23 with the anisotropy conductive film overlaid thereon is switched regularly, the wear of the clamping roller 21 can be reduced.

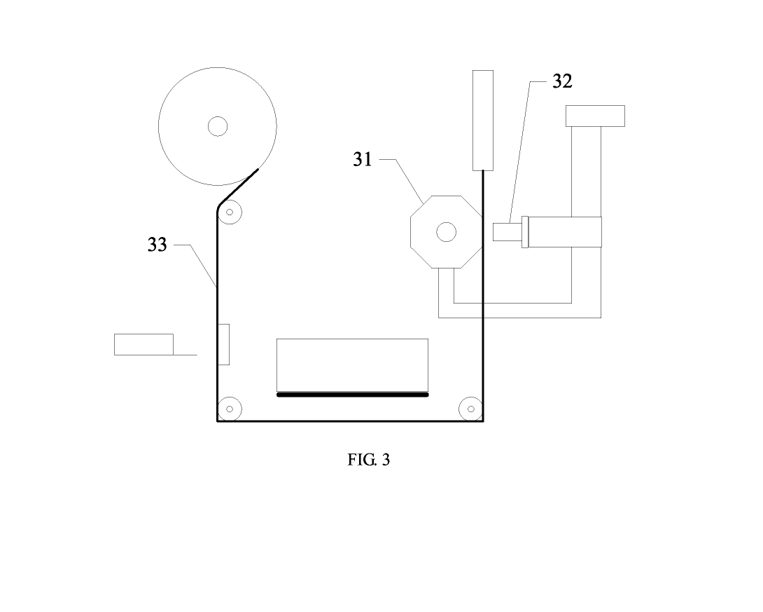

Referring to FIG. 3, a stretching and clamping device for anisotropy conductive film in accordance with a second embodiment is schematically shown. The clamping head 32 of the second embodiment is capable of cooperating with the clamping roller 31. The configuration of the clamping roller 31 of the second embodiment is similar to that of clamping roller of the first embodiment shown in FIG. 2, which is not given in detail again. The clamping head 22 of the second embodiment is cuboid-shaped or cylinder-shaped. If the clamping head 22 is cuboid-shaped, one end of the cuboid corresponding to the surface of the clamping roller 31 is used as a front end of the clamping head 32; if the clamping head 32 is cylinder-shaped, an end of the cylinder corresponding to the surface of the clamping roller 31 is used as the front end of the clamping head 32. With the cuboid-shaped or cylinder-shaped clamping head 32, when clamping the paper strip 33 with the anisotropy conductive film overlaid thereon, one end of the cuboid or cylinder contacts the paper strip 33 with the anisotropy conductive film overlaid thereon. Compared to the present clamping head shaped as a triangular prism, the contacting area between the clamping head 32 of the present disclosure and the paper strip 33 with the anisotropy conductive film overlaid thereon is increased, which increases the friction factor of the clamping roller 31 and avoids a sliding situation during the operation. This allows the length of the stretched anisotropy conductive film to meet product manufacturing specifications, improves the clamping precision and clamping stability, improves the yield rate of the bonding of the anisotropy conductive film, and reduces production cost. Additionally, the surface of the front end of clamping head 32 can be designed to be rough, for example, a number of stripe-shaped grooves can be configured in the surface of the front end to further increase the friction between the clamping head 32 and the paper strip 33 with the anisotropy conductive film overlaid thereon to avoid the sliding situation.

The present disclosure further provides a stretching and clamping device for anisotropy conductive film which includes a clamping roller and a clamping head, wherein the structure of the clamping roller is similar to that of the clamping roller of the embodiments shown in FIGS. 2 and 3 and the structure of the clamping head is similar to that of the clamping head of the embodiment shown in FIGS. 2 and 3. With the structure mentioned above, compared to the present stretching and clamping device for anisotropy conductive film, the stretching and clamping device for anisotropy conductive film of the present disclosure can increase the friction between the stretching and clamping device and the paper strip 23 with the anisotropy conductive film overlaid thereon, avoid a sliding situation occurred during the operation, allow the length of the stretched anisotropy conductive film to meet product manufacturing specification, improve the clamping precision and clamping stability, improve the yield rate of the bonding of the anisotropy conductive film, and reduce production cost.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

1. A clamping roller of a stretching and clamping device for anisotropy conductive film, wherein the clamping roller is shaped as a regular prism and is capable of rotating around a rotating shaft thereof.

2. The clamping roller as claimed in claim 1, wherein a Teflon film is attached on each side of the clamping roller.

3. A clamping head of a stretching and clamping device for anisotropy conductive film used for cooperating with a clamping roller which is shaped as a regular prism and is capable of rotating around a rotating shaft thereof to position and bond the anisotropy conductive film, wherein one end of the clamping head corresponding to one side of the clamping roller is used as a front end of the clamping head, the other end of the clamping head opposite to the front end is connected to a retractable device which is capable of driving the clamping head to move towards the clamping roller or to move away from the clamping roller.

4. (canceled)

5. The clamping head as claimed in claim 3, wherein a surface of the front end of the clamping head is rough.

6. The caching head as claimed in claim 5, wherein a plurality of stripe-shaped grooves are formed in the surface of the front end of the clamping head.

7. The clamping head as claimed in claim 6, wherein the clamping head is cuboid-shaped or cylinder-shaped.

8. A stretching and clamping device for anisotropy conductive film, comprising:
a clamping head;
a clamping roller cooperating with the clamping head to position and bond the anisotropy conductive film, the clamping roller being shaped as a regular prism and being capable of rotating around a rotating shaft thereof.

9. The stretching and clamping device as claimed in claim 8, wherein one end of the clamping head corresponding to one side of the clamping roller is used as a front end of the clamping head, the other end of the clamping head opposite to the front end is connected to a retractable device, and the retractable device drives the clamping head to move towards the clamping roller or to move away from the clamping roller.

10. The stretching and clamping device as claimed in claim 9, wherein a surface of the front end of the clamping head is rough.

11. The stretching and clamping device as claimed in claim 10, wherein a plurality of stripe-shaped grooves are formed in the surface of the front end of the clamping head.

12. The stretching and clamping device as claimed in claim 11, wherein the clamping head is cuboid-shaped or cylinder-shaped.

13. The stretching and clamping device as claimed in claim 12, wherein the clamping head is shaped as a regular eight prism or a regular six prism.

14. The stretching and clamping device as claimed in claim 9, wherein a Teflon film is attached on each side of the clamping roller.

15. The stretching and clamping device as claimed in claim 14, wherein the front end of the clamping roller is cone-shaped.

16. The stretching and clamping device as claimed in claim 8, wherein the clamping roller is made of stainless steel.

17. The stretching and clamping device as claimed in claim 16, wherein a Teflon film is attached on each side of the clamping roller.

18. The stretching and clamping device as claimed in claim 17, wherein one end of the clamping head corresponding to one side of the clamping roller is used as a front end of the clamping head, the other end of the clamping head opposite to the front end is connected to a retractable device, the retractable device drives the clamping head to move towards the clamping roller or to move away from the clamping roller.

19. The stretching and clamping device as claimed in claim 18, wherein a surface of the front end of the clamping head is rough.

20. The stretching and clamping device as claimed in claim 19, wherein a plurality of stripe-shaped grooves are formed in the surface of the front end of the clamping head.
